(19) United States
(12) Patent Application Publication
(10) Pub. No.: US 2014/0021936 A1
(43) Pub. Date: Jan. 23, 2014

(54) HIGH EFFICIENCY ENERGY HARVESTER AND METHODS THEREOF

(71) Applicants: Dan Tho Lu, Minden, NV (US); Ingrid Marie Gilstrap, Gardnerville, NV (US)

(72) Inventors: Dan Tho Lu, Minden, NV (US); Ingrid Marie Gilstrap, Gardnerville, NV (US)

(21) Appl. No.: 13/554,210

(22) Filed: Jul. 20, 2012

(51) Int. Cl. H01F 38/28; H01R 43/00; H01F 27/28

(52) U.S. Cl. 323/358; 336/220; 29/825

(57) ABSTRACT

In one embodiment, a current transducer is provided. The current transducer includes a magnetic core configured to at least partially encircle a magnetic flux generated by a conductor. At least one coil is coupled to the magnetic core and the magnetic core comprises a superm-alloy material.

### BACKGROUND OF THE INVENTION

The field of the invention relates generally to energy harvesting, and more particularly, to a current transducer that extracts energy from a source.

Energy harvesting is a process for recovering power that is otherwise dissipated or lost in a system. For example, known energy harvesting may be used to obtain energy from light, heat, wind, vibrations, electrical currents, and the like. In many known systems, harvested energy may be used in conjunction with battery power to provide power to electronic devices or to charge a battery.

Sensor assemblies are often used in industrial settings to monitor the condition of associated machinery and operations thereof. Known sensor assemblies are often battery powered. Labor costs associated with changing batteries on a regular basis limits commercial viability, especially if the sensors are in remote or inaccessible locations. Further, due to the limited lifetime of batteries, disposal thereof adversely impacts the environment.

### BRIEF DESCRIPTION OF THE INVENTION

In one embodiment, a current transducer is provided. The current transducer includes a magnetic core configured to at least partially encircle a magnetic flux generated by a conductor. At least one coil is coupled to the magnetic core and the magnetic core comprises a superm-alloy material.

In another embodiment, an energy harvesting system is provided. The energy harvesting system includes a current transducer comprising a magnetic core and at least one coil coupled to the core. The current transducer is configured to at least partially encircle a magnetic flux generated by a conductor and is operable to generate electrical voltage from the conductor. The energy harvesting system further includes a step-up transformer electrically coupled to the current transducer to receive the electrical voltage generated by the current transducer. The step-up transformer amplifies the electrical voltage generated by the current transducer to power an electrical device. The magnetic core comprises a superm-alloy material.

In yet another embodiment, a method of assembling an energy harvesting system is disclosed. The method includes providing a current transducer including a magnetic core and at least one coil coupled to the core. The current transducer is configured to at least partially encircle a magnetic flux generated by a conductor and is operable to generate electrical voltage from the conductor. The method further includes providing a step-up transformer electrically coupled to the current transducer to receive the electrical voltage generated by the current transducer. The step-up transformer amplifies the electrical voltage generated by the current transducer to power an electrical device and the magnetic core comprises a superm-alloy material.

In yet another embodiment, a method of energy harvesting is disclosed. The method includes providing a current transducer electrically coupled to a step-up transformer. The current transducer comprises a magnetic core and at least one coil coupled to the core and the magnetic core comprises a superm-alloy. The method further includes positioning the current transducer to at least partially encircle a magnetic flux generated by a conductor and generating electrical voltage with the current transducer. The method further includes amplifying the generated electrical voltage with the step-up transformer.

### BRIEF DESCRIPTION OF THE DRAWINGS

FIG. 1 is a schematic view of an exemplary power system; and

FIG. 2 is a schematic view of an exemplary current transducer used with the system of FIG. 1.

### DETAILED DESCRIPTION OF THE INVENTION

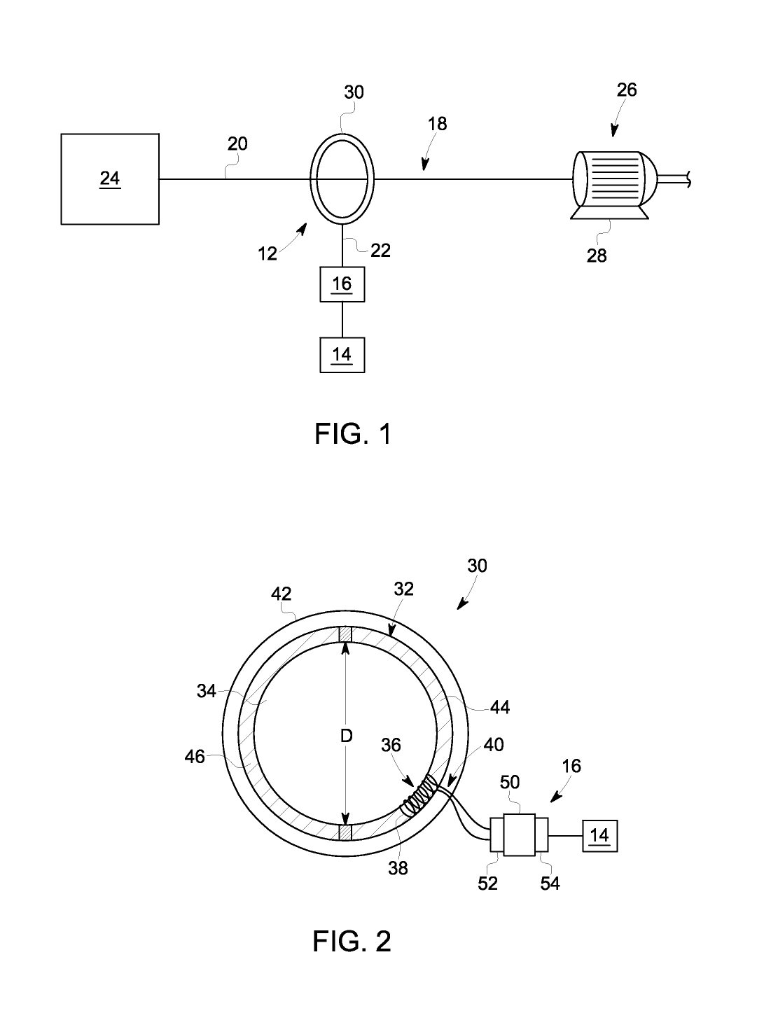

FIG. 1 is a schematic diagram of an exemplary power system 10. Generally, power system 10 includes an energy harvesting device 12 that during use, provides power to a load or energy storage 14 via a step-up transformer 16, in the exemplary embodiment. Moreover, in the exemplary embodiment, energy harvesting device 12 may be an inductive current transducer 30 that converts current, for example AC current, from a conductor 18 by induction to a smaller secondary AC current 22 to supply power for use by load or energy storage 14. In the exemplary embodiment, load 14 may be an electronic device such as, for example, a wireless sensor, a field instrument, a wireless transmitter, a wireless system, or other monitoring device. In the exemplary embodiment, conductor 18 is an insulated cable 20. Alternatively, conductor 18 may be an uninsulated cable or any other material capable of conducting electric current.

A current supply 24 provides current through cable 20 to a device 26. In the exemplary embodiment, device 26 is a motor 28. Alternatively, device 26 may be an electrical system, industrial machinery, or the like. In the exemplary embodiment, step-up transformer 16 is electrically connected between current transducer 30 and load 14 to facilitate amplifying voltage received from current transducer 30. Thus, energy harvesting device 12 extracts energy from cable 20 to power load 14. Current transducer 30 may provide sufficient power to operate load 14, thus eliminating the need for a battery or auxiliary source of power.

FIG. 2 illustrates an exemplary embodiment of inductive current transducer 30 that may be used with system 10. Generally, in the exemplary embodiment, current transducer 30 includes a magnetic core 32 including a central opening 34 extending therethrough. Conductor 18 extends at least partially through central opening 34 such that magnetic core 32 at least partially encircles a magnetic flux produced by conductor 18, and at least one coil 36 is wrapped about core 32. In the exemplary embodiment, coil 36 includes a plurality of windings 38. Alternatively, coil 36 may be a single winding 38. Coil 36 is coupled to a terminal 40 for use in electrically coupling step-up transformer 16 and load 14. Alternatively, more than one current transducer 30 may be positioned about conductor 18 and electrically coupled to step-up transformer 16 or to a separate step-up transformer 16 (not shown).

Moreover, in the exemplary embodiment, core 32 and coil 36 are housed in a housing 42. Housing 42 may be fabricated from any suitable material, such as plastic, that enables current transducer 30 to operate as described herein. Alternatively, step-up transformer 16 and/or load or energy storage 14 may also be housed in housing 42.

In the exemplary embodiment, windings 38 may be wound about a portion or all of core 32. Alternatively, current transducer 30 may have a plurality of coils 36 operationally coupled thereto. In the exemplary embodiment, a locking mechanism (not shown) is used to secure coil 36 to core 32 and such mechanism may be permanently coupled to core 32 via any fastening mechanism, such as, but not limited to, adhesives and/or banding. Alternatively, locking mechanisms may removeably couple to core 32 via, for example, a bracket and/or clamp.

In the exemplary embodiment, magnetic core 32 is substantially circular. Alternatively, core 32 may be toroidal, triangular, square, or polygonal shaped. In the exemplary embodiment, magnetic core 32 is a split core that includes a first portion 44 and a second portion 46. Moreover, in the exemplary embodiment, first and second portions 44 and 46 are removeably coupled to each other such that core 32 may be conveniently positioned about conductor 18 at any location without having to disconnect conductor 18 from current supply 24 or device 26. This may be particularly advantageous when conductor 18 is a cable 20 having a long length measured from a first end to a second end of cable 20. Although first and second portions 44 and 46 are each half-circles in the exemplary embodiment, first and second portions 44 and 46 may have any other shape that enables them to function as described herein. Alternatively, core 32 may be a single unitary core. Moreover, more than one core 32 may be positioned about conductor 18 and electrically coupled to step-up transformer 16.

In the exemplary embodiment, magnetic core 32 is fabricated from a superm-alloy material. Superm-alloy material is fabricated from approximately 80% nickel, 5% molybdenum and iron, which produces a material with high magnetic permeability and low coercivity. Known split core current transducers suffer significant loss of magnetic energy due to the separation of the respective cores. In contrast to known split core current transducers, because the present magnetic core 32 is fabricated from a superm-alloy material, core 32 has a high magnetic permeability that facilitates current transducer 30 operating at a relatively high efficiency while providing sufficient power to load 14. For example, magnetic core 32 has a permeability greater than 50,000μᵣ.

Core 32 has a diameter D measured between first and second portions 44 and 46. In the exemplary embodiment, diameter D is between approximately 1 cm and 100 cm. More particularly, in the exemplary embodiment, diameter D is between approximately 25 cm and 75 cm. Alternatively, core 32 may have any diameter D that enables energy harvesting device 12 to function as described herein.

In the exemplary embodiment, magnetic flux generated by conductor 18 induces a current on coil windings 38. In the exemplary embodiment, current passes from coil 36 via terminal 40 as secondary current 22 received by transformer 16.

In the exemplary embodiment, step-up transformer 16 includes a housing 50, an input side 52, and an output side 54. Secondary current 22 is received at input side 52 and the input voltage is amplified to a much higher voltage at output side 54, for example, in one embodiment. Step-up transformer 16 provides, for example, an electric signal between 5V and 12V from output side 54. However, step-up transformer 16 may provide any voltage signal that enables power system 10 to function as described herein.

As described above, load 14 may be a monitoring device to monitor the health of a system or components such as pumps, motors, turbines, engines or an industrial process. In the exemplary embodiment, current passes from output side 54 to load 14. In the exemplary embodiment, load 14 may be a machine condition monitoring system that measures key indicators such as vibrations, temperatures and pressures of critical machines, and tracks the information over time to look for abnormalities. As discussed, load 14 may be an electronic device such as, for example, a wireless sensor, a field instrument, a wireless transmitter, a wireless system, or other monitoring device. Load 14 uses secondary current 22 from output side 54 of step-up transformer 16 to power any monitoring or transmitting/receiving functions of load 14, thus reducing the need for power from an alternate source.

In operation, current transducer 30 is provided. Current transducer 30 is positioned about conductor 18 such that conductor 18 passes at least partially through central opening 34. Current transducer 30 is electrically coupled to step-up transformer 16, which is electrically coupled to load 14. Current passing through conductor 18 generates magnetic flux, which induces an AC current on coil 36. The induced current travels via terminals 40 to step-up transformer input side 52 where it is amplified to a higher voltage. The amplified current travels from step-up transformer output side 54 to load or energy storage 14 where it is used to power load 14 or stored for later use.

The exemplary energy harvester described herein generates power from an existing power cable with an inductive current transducer in a cost effective and reliable manner. This allows the energy harvester to be useful in extremely small and/or remote locations, such as in deep-sea or space applications. Advantageously, because of the non-existence of, or significantly reduced number of moving parts, the energy harvester is simpler and less expensive to manufacture than known energy harvesters. By harvesting power from the environment, sensors can be made self-sufficient over their lifetime with virtually no maintenance. Thus, the exemplary energy harvester described herein can be built integral with wireless sensors for maintenance free machine-condition monitoring. Compared to known sensors, batteries used to power wireless sensors may be reduced in size or even eliminated in the current systems, thus reducing maintenance and environmental impact.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A current transducer comprising:
a magnetic core configured to at least partially encircle a magnetic field generated by a conductor; and
at least one coil coupled to said magnetic core, wherein said magnetic core comprises a superm-alloy material.

2. The current transducer of claim 1, wherein said magnetic core is substantially circular.

3. The current transducer of claim 1, wherein said magnetic core is polygonal-shaped.

4. The current transducer of claim 1, wherein said magnetic core is substantially toroidal.

5. The current transducer of claim 1, wherein said magnetic core comprises a split core.

6. The current transducer of claim 1, wherein said magnetic core comprises an opening therethrough for receiving the conductor.

7. The current transducer of claim 1, wherein said at least one coil comprises at least one set of windings spaced substantially evenly about said core.

8. An energy harvesting system comprising:
a current transducer comprising a magnetic core and at least one coil coupled to said core, said current transducer configured to at least partially encircle a magnetic flux generated by a conductor and operable to generate electrical voltage from the conductor;
a step-up transformer electrically coupled to said current transducer to receive said electrical voltage generated by said current transducer, wherein said step-up transformer amplifies said electrical voltage generated by said current transducer to power an electrical device; and
wherein said magnetic core comprises a superm-alloy material.

9. The energy harvesting system of claim 8, wherein said magnetic core is substantially circular.

10. The energy harvesting system of claim 8, wherein said magnetic core is substantially toroidal.

11. The energy harvesting system of claim 8, wherein said magnetic core comprises a split core.

12. The energy harvesting system of claim 8, wherein said magnetic core comprises an opening extending therethrough for receiving the conductor.

13. The energy harvesting system of claim 12, further comprising a current-carrying cable extending through said opening.

14. The energy harvesting system of claim 8, wherein said at least one coil comprises at least one set of windings spaced substantially evenly about said core.

15. The energy harvesting system of claim 8, wherein said electrical device is at least one of a wireless sensor, a wireless transmitter, and a wireless system.

16. The energy harvesting system of claim 8, wherein said electrical device monitors an industrial process.

17. A method of assembling an energy harvesting system comprising:
providing a current transducer comprising a magnetic core and at least one coil coupled to the core, the current transducer configured to at least partially encircle a magnetic flux generated by a conductor and operable to generate electrical voltage from the conductor;
providing a step-up transformer electrically coupled to the current transducer to receive the electrical voltage generated by the current transducer, wherein the step-up transformer amplifies the electrical voltage generated by the current transducer to power an electrical device; and
wherein the magnetic core comprises a superm-alloy material.

18. The method of claim 17, further comprising electrically coupling at least one of a wireless sensor, a wireless transmitter, and a wireless system to the step-up transformer to receive the electrical voltage generated by the current transducer.

19. A method of energy harvesting comprising:
providing a current transducer electrically coupled to a step-up transformer, the current transducer comprising a magnetic core and at least one coil coupled to the core, wherein the magnetic core comprises a superm-alloy;
positioning the current transducer to at least partially encircle a magnetic flux generated by a conductor;
generating electrical voltage with the current transducer;
amplifying the generated electrical voltage with the step-up transformer.

20. The method of claim 19, further comprising delivering the amplified voltage to at least one of a load and an energy storage device.
